(19) United States
(12) Patent Application Publication
(10) Pub. No.: US 2006/0168874 A1
(43) Pub. Date: Aug. 3, 2006

(54) Flashing fishing driver

(76) Inventor: Dennis H. Hull, Keizer, OR (US)

Correspondence Address: Teri G. Andrews;Attorney at Law, 907 NW Raintree Dr., Corvallis, OR, 97330, US

(21) Appl. No.: 11/342,954

(22) Filed: Jan. 30, 2006

Related U.S. Application Data
(60) Provisional application No. 60/649,491, filed on Feb. 3, 2005.

(51) Int. Cl. A01K 91/08

(52) U.S. Cl. 43/43.13

(57) ABSTRACT

The fishing diver of the present invention has a diver body that has a top surface, a bottom surface, a front edge and a rear edge. The diver body is coated with a reflective coating with the exception of a coating free portion located approximately in the middle of the diver body. There is an attractor attachment means extending from the diver bottom surface for attaching a user selectable flasher attractor. A line to a fishing pole extends from the diver body front edge and a line to a hook or lure extends from the diver body rear edge. Light from above projects through the coating free portion of the diver body onto the attached flasher attractor below. A portion of the light reflects off the flasher attractor onto the bottom surface of the diver body and then in a downward direction; and another portion of the light reflects off the flasher attractor and in a more outward direction.

### BACKGROUND OF THE INVENTION

1. Field of the Invention

This invention relates to a fishing apparatus, and more particularly to an improved fishing diver that allows a user selectable fishing flasher or attractor to be attached directly under the diver for attracting fish while trolling.

2. Prior Art

Divers, also known as planers typically have a weighted front edge, a means for connecting the diver to a fishing pole or rod, a planing surface and a means of connecting the back or trailing edge to baited hooks or lures. When trolled or moved forward through the water, the weighted front or leading edge causes the diver to dive at a downward angle which allows the user to control and maintain the depth at which the baited hook or lure is fishing. It is common to use an attractor or flasher in-line with the diver assembly. The flasher is tied in the leader or line between the diver and the baited hook to provide additional fish attracting light reflected to the baited hook or lure presentation.

While the use of flashers or attractors can aid in the attraction of fish, they also have problems associated with their use. Flashers or attractors have many different actions when moved or trolled through the water such as rotating, wobbling, spinning, or darting side-to-side. These erratic movements imparted by the flasher in the leader to the baited hook or lure often result in tangled lines that require cutting and retying the leader to the baited hook or lure as well as the fishing line connecting the diver to the fishing pole or rod. This need for retying gear results in less time spent fishing effectively.

There are many different designs of fishing divers or planers currently in use and available for purchase. These available divers all accomplish the effect of controlling depth and have many different fish attracting characteristics such as metallic finish, brightly colored finish or have reflective tape or similar material applied to them for reflecting light from the surface of the diver. The problem with these divers or planers is that the fish approach from the back or underside of the diver where these surfaces, even if reflective, receive no light from above. As a result, they offer no reflective properties to the underside or back side of the diver where the fish approach.

There is a need for a flashing fishing diver that provides means of projecting light in a more downward direction where the fish are more likely to be and, therefore, see. This fishing diver should also enable the fisherman to change flashers or attractors quickly and easily. Additionally, this diver should also keep the flasher or attractor from tangling or wrapping the leader to the baited hook.

### OBJECTS AND ADVANTAGES OF THE PRESENT INVENTION

It is an object of the present invention to provide a fishing diver with a fishing flasher attractor attached to the underside or back side of the fishing diver allowing it to operate directly under the diver as a part of the diver rather than having a flasher attractor trailing behind the diver tied in-line with the leader to the baited hook. This improved attachment method eliminates line tangles typically associated with in-line flasher attractors.

It is also an object of the present invention to provide a diver with means for light from above to be projected through the planing surface of the diver onto a flasher attractor moving below the underside or backside of the diver. At least a portion of the light is then reflected upwards to the backside of the diver thereby illuminating the back or underside of the diver. The light is reflected both outward to the sides as well as back downward to the flasher attractor thereby significantly increasing the reflective properties of both and increasing the visibility and attraction to fish.

It is yet another object of the present invention to provide a fishing diver that allows for user selectable sizes, shapes and configurations of flasher attractors which can be quickly and easily changed without having to tie in-line with the baited hook or lure.

Still further objects and advantages of the present invention will become apparent from a consideration of the ensuing description and drawings.

### SUMMARY OF THE INVENTION

The fishing diver of the present invention has a diver body that has a top surface, a bottom surface, a front edge and a rear edge. The diver body is coated with a reflective coating with the exception of a coating free portion located approximately in the middle of the diver body. There is an attractor attachment means extending from the diver bottom surface for attaching a user selectable flasher attractor. A line to a fishing pole extends from the diver body front edge and a line to a hook or lure extends from the diver body rear edge. Light from above projects through the coating free portion of the diver body onto the attached flasher attractor below. A portion of the light reflects off the flasher attractor onto the bottom surface of the diver body and then in a downward direction; and, another portion of the light reflects off the flasher attractor and in a more outward direction.

### BRIEF DESCRIPTION OF THE DRAWINGS

FIG. 1 is a perspective view of the preferred embodiment of the present invention.

FIG. 2 is a side view of the fishing diver of the preferred embodiment of the present invention depicting the position of the diver while diving and the light reflective properties of the preferred embodiment.

FIG. 3 is a side view of the fishing diver of the preferred embodiment of the present invention depicting the position of the diver with a fish on or when the diver is being reeled in.

### DRAWINGS—REFERENCE NUMERALS

100 Fishing Diver Assembly

101 Lead Weight

102 Diver Top Surface

103 Swivel

104 Bait Line

105 Hook

106 Tape Free Window

107 Attractor Attach Means

108 Flasher Attractor

109 Diver Body

110 Reflective Tape

111 Attractor Swivel

112 Slide Rod

113 Attractor Attach Means Threaded End

115 Securing Nuts

117 Diver Front Edge

118 Diver Bottom Edge

201 Diver Bottom Surface

203 Slide Rod Threaded End

209 Downward Light

214 Hook Swivel

216 Reflected light

### DETAILED DISCUSSION OF THE PREFERRED EMBODIMENTS

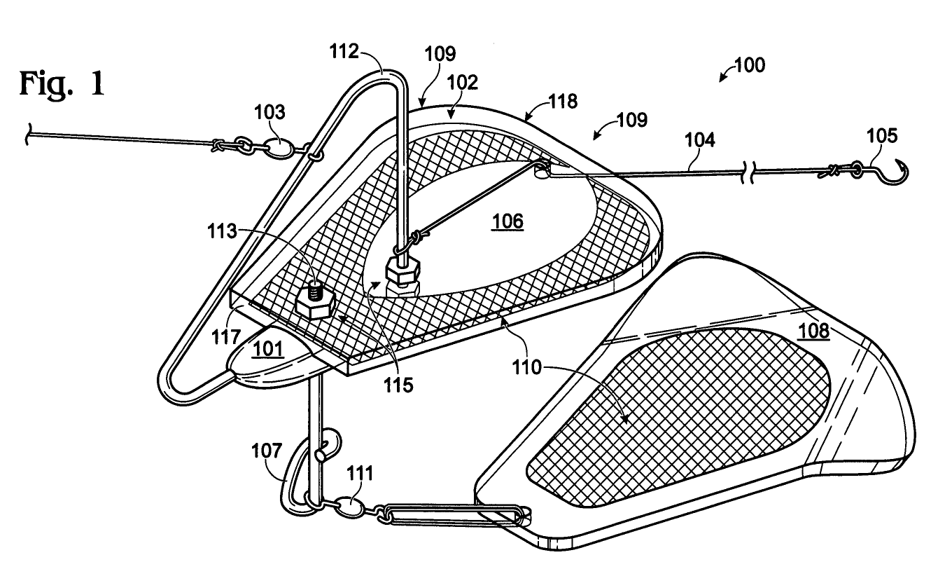

Referring to the FIG. 1 through 3, like elements retain their indicators throughout the several views.

FIG. 1 is a perspective view of Fishing Diver Assembly 100 of the preferred embodiment of the present invention. Fishing Diver Assembly 100 is pulled through the water by a line attached to Swivel 103. Diver Body 109 has a Diver Front Edge 117 which leads while Fishing Diver Assembly 100 is pulled through the water, while Diver Rear Edge 118 follows. Diver Body 109 is preferably made from acrylic or plastic. The acrylic or plastic can be either clear or colored, but preferably transparent. In the preferred embodiment, Slide Rod 112 extends through Diver Body 109 and is attached by Securing Nut 115 screwed onto a threaded end (not shown) of Slide Rod 112. One Securing Nut 115 is on Diver Top Surface 102 and the other (shown in phantom) is screwed from the bottom surface to hold Slide Rod 112 firmly in place. In the preferred embodiment, the other end of Slide Rod 112 is embedded into Lead Weight 101 that is attached to Diver Body 109 by Attractor Attach Means 107. Attractor Attach Means 107 has an Attractor Attach Means Threaded End 113 on one end with a closed loop formed at the opposing end. Attractor Attach Means 107 is attached to Diver Body 109 by Attractor Attach Threaded End 113 extending through Lead Weight 101 and then through to Diver Top Surface 102 of the Diver Body 109. Securing Nut 115 is screwed onto Attractor Attach Threaded End 113 thereby fixedly attaching Attractor Attach means 107 to the diver body. Although the preferred embodiment shows Attractor Attach Means 107 and Slide Rod 112 attached to Diver Body 109 with Securing Nuts 115, it has also been contemplated to have them attached with rivets or other attachment means.

As shown in FIG. 1, Bait Line 104 is attached to Slide Rod 112, goes through Diver Body 102, and extends out from Diver Rear Edge 118 where Hook 105 is attached to the opposing end of Bait Line 104 for catching fish. Hook 105 is shown in the preferred embodiment as a simple hook, but can also be a user selectable lure.

When the boat is slowly moving through the water, or trolling, the weight of Lead Weight 101 pulls Diver Front Edge 117 downward thereby sliding Swivel 103 up Slide Rod 112 and back toward Diver Read Edge 118 as shown in FIG. 1. This puts Fishing Diver Assembly 100 into a diving position so that as it is pulled through the water, it moves downward or dives to the desired depths. As with all divers, depth is controlled by length of line and speed of the boat.

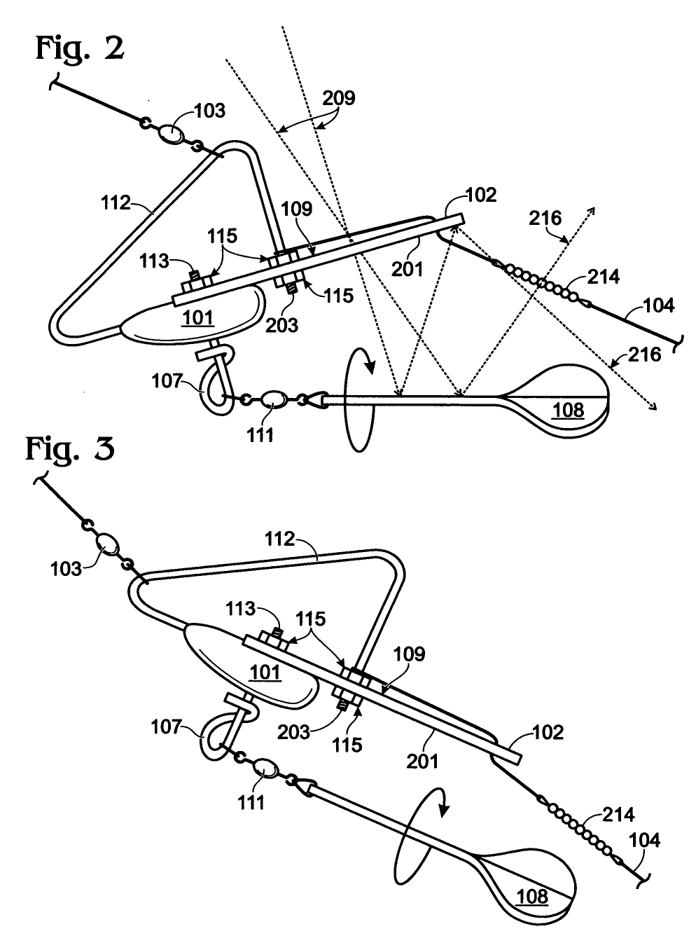

From the loop of Attractor Attach Means 107 at the end opposite from Attractor Attach Threaded End 113 is a slideably attached Attractor Swivel 111. A user selectable Flasher Attractor 108 is attached to Attractor Swivel 111. In the preferred embodiment, Flash Attractor 108 as well as the bottom surface of Diver Body 109 is covered with Reflective Tape 110 with the exception of Tape Free Window 106. Keeping Reflective Tape 110 from Tape Free Window 106 allows light to come through Diver Body 109 and reflect off Flasher Attractor 108 which will be shown and discussed in more detail in FIG. 2. Although the preferred embodiment shows a plastic, holographic taped Flasher Attractor 108, the choice of Flasher Attractor 108 is user selectable and may have many different fish attracting characteristics such as metallic finishes, brightly colored finishes or have reflective tape or similar material applied to them for reflecting light from the surfaces of Diver Body 109. It has also been contemplated that the reflective means or tape may be attached to either Diver Top Surface 102 or Diver Bottom Surface 201 (shown and discussed further in FIG. 2) of Diver Body 109 of the Fishing Diver Assembly 100.

FIG. 2 is a side view of Fishing Diver Assembly 100 of the preferred embodiment of the present invention depicting the position of the Fishing Diver Assembly 100 while diving and the resulting improved light reflective properties. As previously discussed, when diving, Swivel 103 is slid back on Slide Rod 112 so that Diver Body 109 is tilted downward.

FIG. 2 shows Slide Rod 112 extending from Diver Top Surface 102 through to Diver Bottom Surface 201 where Securing Nut 115 is screwed to Slide Rod Threaded End 203 thereby securing Slide Rod 112 to Diver Body 109 of Fishing Diver Assembly 100. Hook Swivel 214 is shown attached to Bait Line 104 for ease of attaching Hook 105 or a user selectable lure as previously discussed. FIG. 2 shows a side view of Flasher Attractor 108 with a rotational arrow indicating that Flasher Attractor 108 is spinning.

Downward Light 209 is shown projected from above through Tape Free Window 106 (not shown) onto Flasher Attractor 108. The resulting Reflected Light 216 reflects off Flasher Attractor 108 in several directions depending on its spinning or wobbling. As depicted in FIG. 2, part of Reflected Light 216 reflects off Flasher Attractor 108 and onto Diver Bottom Surface 201 and then somewhat downward, while another part reflects onto Flasher Attractor 108 and then somewhat upward and outward. With the light projecting through Tape Free Window 106 incident on Flasher Attractor 108 which is typically fluttering and spinning, light is reflected in many directions. Since the fish are typically looking out or up for their food, the ability to flash light downward and outward is very advantageous to attracting and catching fish. The prior art flash attractors typically project primarily upward light.

Alternate embodiments have been contemplated that would have a more flat flasher attractor that would flutter rather than spin. This type of flasher attractor will produce a different light reflecting pattern and may be preferred for various species of fish.

FIG. 3 is a side view of Fishing Diver Assembly 100 of the preferred embodiment of the present invention depicting the position of Fishing Diver Assembly 100 with a fish on or when the diver is being reeled in. As shown, Swivel 103 has slid to a more forward position on Slide Rod 112 thereby tilting Diver Body 109 to an upward position. Flasher Attractor 108 is in a somewhat parallel position with respect to the remaining portions of Fishing Diver Assembly 100. This parallel position keeps Flasher Attractor 108 from getting tangled up with Bait Line 104 and/or Hook 105. When Fishing Diver Assembly 100 is finally pulled out of the water, Flasher Attractor 108 is free from Bait Line 104 and not likely to be tangled. Flasher Attractor 108 can now be quickly changed without having to re-tie the bait line of the diving assembly.

Wherein the terms and expressions which have been employed in the foregoing specification are used therein as terms of description and not of limitation, there is no intention, in the use of such terms and expressions, of excluding equivalents of the features shown and described or portions thereof, it being recognized that the scope of the invention is defined and limited only by the claims which follow.

I Claim:

1. A fishing diver, comprising:
a diver body having a diver top surface, a diver bottom surface, a diver front edge, and a diver rear edge, said diver body having an attached reflective coating parallel to and approximate the size of said diver body;
an attractor attachment means extending from said diver bottom surface for attaching a user selectable flasher attractor;
a pole line extending from said diver front edge for attaching to a fishing pole; and
a bait line extending from said diver rear edge for attaching a hook.

2. The fishing diver of claim 1, wherein said reflective coating is on said diver top surface.

3. The fishing diver of claim 1, wherein said reflective coating is on said diver bottom surface.

4. The fishing diver of claim 1, wherein said reflective coating is holographic tape.

5. The fishing diver of claim 1, wherein said reflective coating is reflective tape.

6. The fishing diver of claim 1, wherein said reflective coating having a coating free portion approximate the center of said diver body, said coating free portion having no said attached reflective coating thereby allowing light to project through said diver body onto said user selectable flasher attractor attached below said diver body.

7. The fishing diver of claim 6, wherein said coating free portion is a substantially round shape and is less than half the area of said attached reflective coating.

8. The fishing diver of claim 6, wherein said coating free portion is less than half the area of said attached reflective coating.

9. The fishing diver of claim 1, wherein said diver body is made of plastic.

10. The fishing diver of claim 1, wherein said diver body is made of acrylic.

11. An improved fishing diver, comprising:
a diver body having a diver top surface, a diver bottom surface, a diver front edge, and a diver rear edge, said diver body having an attached reflective coating parallel to and approximate the size of said diver body, said reflective coating having a coating free portion;
an attractor attachment means extending from said diver bottom surface for attaching a user selectable flasher attractor;
a bait line extending from said diver rear edge for attaching a hook;
a slide rod fixedly attached to said diver body top surface extending essentially perpendicular to said diver body, bending at approximately 45 degrees and extending slightly beyond said diver front edge and bending back to attached to diver front edge thereby creating a triangular attachment bail; and
a pole line slideably attached to said triangular attachment bail for attaching to a fishing pole;
wherein sunlight from above projects through said coating free portion of said reflective coating and reflects off said user selectable flasher attractor creating an array of flashing light for attracting and thereby catching fish on said hook.

12. The improved fishing diver of claim 11, wherein said reflective coating is attached to said diver top surface.

13. The improved fishing diver of claim 11, wherein said reflective coating is attached to said diver bottom surface.

14. The improved fishing diver of claim 11, wherein said coating free portion is a substantially round shape and is less than half the area of said attached reflective coating.

15. The improved fishing diver of claim 11, wherein said coating free portion is less than half the area of said attached reflective coating.

16. The improved fishing diver of claim 11, wherein said diver body is made of plastic.

17. The improved fishing diver of claim 11, wherein said diver body is made of acrylic.

18. The improved fishing diver of claim 11, wherein said attached reflective coating is halographic tape.

19. The improved fishing diver of claim 11, wherein said attached reflective coating is reflective tape.
